(19) United States
(12) Patent Application Publication
(10) Pub. No.: US 2026/0162256 A1
(43) Pub. Date: Jun. 11, 2026

(54) QUANTIFICATION OF DEFICIENT OCULAR IMAGE FEATURES BASED ON MACHINE LEARNING

(71) Applicant: Alcon Inc., Fribourg (CH)

(72) Inventors: Bryan Stanfill, Mansfield, TX (US); Robert Dimitri Angelopoulos, San Jose, CA (US); Shruti Siva Kumar, Foothill Ranch, CA (US)

(21) Appl. No.: 19/394,130

(22) Filed: Nov. 19, 2025

Related U.S. Application Data
(60) Provisional application No. 63/729,129, filed on Dec. 6, 2024.

(51) Int. Cl. G06T 7/00; G06N 3/0475; G06N 3/048; G06V 40/18

(52) U.S. Cl. CPC G06T 7/0012; G06N 3/0475; G06N 3/048; G06V 40/193; G06T 2207/10056; G06T 2207/10101; G06T 2207/20084

(57) ABSTRACT

A system for assessing an eye using an optical coherence tomography (“OCT”) device includes a controller having at least one processor and at least one non-transitory, tangible memory on which instructions are recorded. The controller is adapted to receive an original OCT image of the eye captured via an OCT device. At least one learning module is selectively executable by the controller. The learning module is trained by a training network with a dataset having respective historical ultrasound bio-microscopy images and respective historical OCT images. The controller is adapted to receive input data, including the original OCT image and biometric parameters of the eye. The controller is adapted to execute the at least one learning module to generate one or more quantified image features based on the original OCT input data. The quantified image features include a lens thickness and a lens diameter.

### INTRODUCTION

The disclosure relates generally to assessment of ocular image features obtained via an optical coherence tomography (“OCT”) device. More particularly, the disclosure relates to quantifying OCT image features of the eye that are deficient or incomplete using machine learning. OCT is a noninvasive imaging technology using low-coherence interferometry to generate high-resolution images of ocular structure. OCT imaging functions partly by measuring the echo time delay and magnitude of backscattered light. Images generated by OCT are useful for many purposes, such as identification and assessment of ocular diseases. OCT images are frequently taken prior to cataract surgery, where an intraocular lens is implanted into a patient's eye. An inherent limitation of OCT imaging is that the illuminating beam cannot penetrate across the iris. Hence many features in the peripheral regions of the eye, such as the crystalline lens structure behind the iris, are incomplete or not available.

### SUMMARY

Disclosed herein is a system for assessing an eye using an optical coherence tomography (“OCT”) device. The system includes a controller having at least one processor and at least one non-transitory, tangible memory on which instructions are recorded. The controller is adapted to receive an original OCT image of the eye captured via an OCT device. At least one learning module is selectively executable by the controller. The learning module is trained by a training network with a dataset having respective historical ultrasound bio-microscopy images and respective historical OCT images. The controller is adapted to receive input data, including the original OCT image and biometric parameters of the eye. The controller is adapted to execute the at least one learning module to generate one or more quantified image features based on the original OCT input data. The quantified image features include a lens thickness and a lens diameter.

The input data from the original OCT image may include an anterior lens surface curvature, a posterior lens surface and a thickness of a lens. The biometric parameters may include an axial length, corneal keratometry, and an anterior chamber depth. The quantified image features may include a cataract grading score. The quantified image features includes an equatorial plane position of a lens in the eye. The equatorial plane position is measured from at least one of an anterior phakic pole of the eye, an anterior chamber depth of the eye, and a posterior phakic pole of the eye.

In some embodiments, the learning module incorporates a boosted neural network having a plurality of neural networks fitted together. The training network may be a generative adversarial network having a generator adapted to generate respective synthesized quantified image features based in part on the respective historical OCT images and respective historical biometric parameters. The training network may include a discriminator adapted to compare the respective synthesized quantified image features output by the generator and respective quantified image features obtained from the respective historical ultrasound bio-microscopy images. Here, training of the learning module is completed when a difference between the respective synthesized quantified image features output by the generator and the respective quantified image features obtained from the respective historical ultrasound bio-microscopy images is above a predefined threshold.

Disclosed herein is a method for assessing an eye using an optical coherence tomography (“OCT”) device, with a system having a controller with at least one processor and at least one non-transitory, tangible memory. The method includes adapting the controller to selectively execute at least one learning module. The method includes training the at least one learning module, via a training network with a dataset having respective historical ultrasound bio-microscopy images and respective historical OCT images. The method includes receiving input data of the eye, via the controller, including biometric parameters of the eye an original OCT image of the eye captured via an OCT device. The method includes executing the at least one learning module to generate one or more quantified image features based on the input data, the one or more quantified image features including a lens thickness and a lens diameter of the eye.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic illustration of a system for quantifying ocular image features, the system having a controller and one or more machine learning modules;

FIG. 2 is a schematic sectional diagram of an example eye;

FIG. 3 is a schematic flowchart for an example method executable by the controller of FIG. 1;

FIG. 4 is a schematic illustration of an example ultrasound bio-microscopy (UBM) image of an eye;

FIG. 5 is a schematic flowchart for an example training method for the learning modules of FIG. 1; and

FIG. 6 is a schematic diagram illustrating a boosted neural network employable in the system of FIG. 1.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

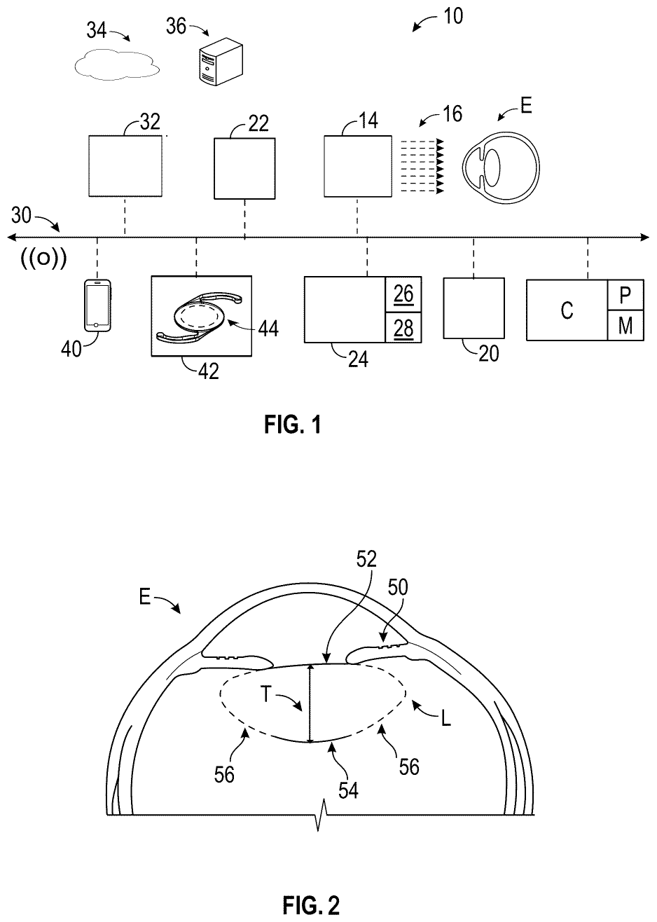

Referring to the drawings, wherein like reference numbers refer to like components, FIG. 1 schematically illustrates a system 10 for assessing an eye E with data captured via an optical coherence tomography image (“OCT” hereinafter) device 14. The OCT device 14 may employ an array of laser beams 16 for illuminating the eye E, with the array of laser beams 16 covering the span of the eye E. In one example, the OCT device 14 is an anterior segment high definition OCT imaging device. The OCT device 14 may employ swept-source OCT. It is to be understood that the OCT device 14 may take many different forms and include multiple and/or alternate components.

Prior to cataract surgery, ophthalmic surgeons make use of a wide variety of algorithms to plan for intraocular lens replacement in order to best correct vision. OCT images provide data input to these algorithms. An example image of an eye E is shown in FIG. 2, with a crystalline lens L and iris 50. OCT images provide clear images of the patient's anterior segment, showing an anterior lens surface curvature 52 and a posterior lens surface curvature 54 of the lens L. However, they cannot be used directly to measure the features of the patient's crystalline lens L because the iris 50 blocks the instrument's view. In other words, features in the peripheral regions 56 (see FIG. 2) of the crystalline lens L behind the iris 50 are deficient.

Factors such as the lens diameter and equatorial plane position of the lens L can be currently measured using ultrasound bio-microscopy videos. However, collecting ultrasound bio-microscopy videos is a time consuming and uncomfortable process for the site technicians and the patient.

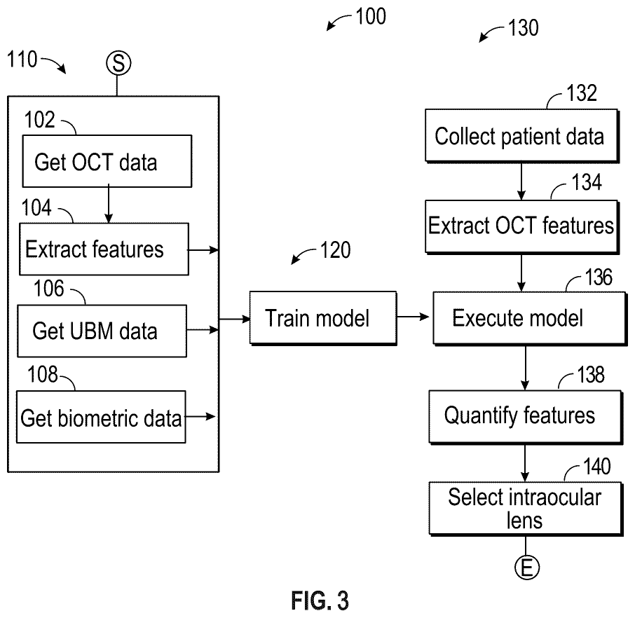

Referring to FIG. 1, the system 10 includes a controller C having at least one processor P and at least one memory M (or non-transitory, tangible computer readable storage medium) on which instructions are recorded for executing method 100 for quantifying deficient image features of an eye E. Method 100 is shown in and described below with reference to FIG. 3.

As described below, the system 10 enables the quantification of ocular measurements for image features of the eye E that are not fully visible in the OCT image. The system 10 is trained in images of lens shapes in-situ, making it robust. Further, the system 10 employs additional features of the eye that are correlated with the measurements of interest of the lens L. For example, the system 10 uses the visible portion of the patient's anterior segment plus additional biometry collected on the patient by other instruments to predict the un-measurable crystalline lens metrics, including but not limited to the lens diameter (LD) and equatorial plane position (EPP). Accordingly, the system 10 produces estimates of the patient's lens geometry consistent with other instruments and without having to image the features directly or estimate the full volume of the crystalline lens.

The prediction task is accomplished using one or more machine learning modules 20 trained on lens measurements collected from alternative instruments, such as ultrasound bio-microscopy, and ocular biometry. Referring to FIG. 1, the controller C is specifically programmed to selectively execute one or more machine learning modules 20, which may be embedded in the controller C or stored elsewhere and accessible to the controller C. The machine learning modules 20 may be configured to find parameters, weights or a structure that minimizes a respective cost function.

Understanding the crystalline lens feature dimensions can indicate the potential of where a lens will end up post operatively, thus informing the effective lens position of the IOL upon implantation. Cataract planning is made more robust by characterizing the feature dimensions of the crystalline lens useful for predicting lens fitting and positioning post cataract. Having this ability enables a predictive model which provides a greater probability of accurately predicting effective lens position post-cataract. Additionally, in accommodating IOLs (AIOL) there is a sizing component to lens selection, therefore having access to the crystalline lens feature dimensions allows greater flexibility in AIOL lens selection. For example, knowing the feature dimensions will enable proper sizing of the AIOL, as well as predicting the resulting power of the AIOL upon implantation.

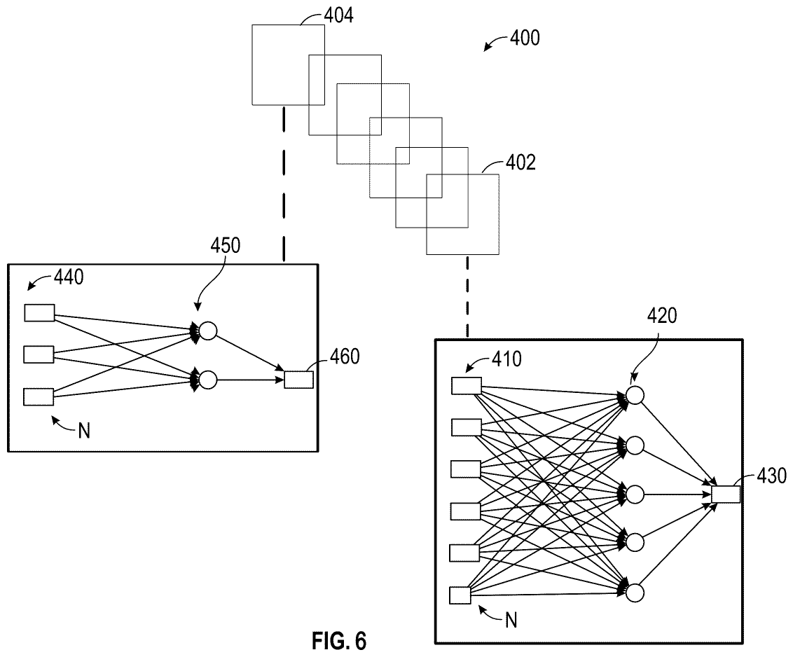

Referring to FIG. 1, the machine learning modules 20 are trained with one or more training datasets from multiple facilities 22, via a training network 24. The facilities 22 may be clinical sites located all over the world. The training dataset includes respective historical sets for a large number of patients. The training network 24 may leverage convolutional neural network (CNN)-based deep learning techniques. In some embodiments, the training network 24 incorporates a deep learning architecture, such as a generative adversarial network (GAN), for training a generator 26, coupled with a discriminator 28. An example of this embodiment is described below with respect to FIG. 6. It is to be understood that the system 10 is not limited to a specific deep neural network methodology.

The various components of the system 10 of FIG. 1 may communicate via a network 30. The network 30 may be a bus implemented in various ways, such as for example, a serial communication bus in the form of a local area network. The local area network may include, but is not limited to, a Controller Area Network (CAN), a Controller Area Network with Flexible Data Rate (CAN-FD), Ethernet, blue tooth, WIFI and other forms of data connection. The network 30 may be a Wireless Local Area Network (LAN) which links multiple devices using a wireless distribution method, a Wireless Metropolitan Area Networks (MAN) which connects several wireless LANs or a Wireless Wide Area Network (WAN). Other types of connections may be employed.

Referring to FIG. 1, the system 10 may include a data management module 32 having a computerized data management system able to store information from the respective electronic medical records of the multiple facilities 22. The data management module 32 may interact with a cloud unit 34 and/or a remote server 36 and be configured to share data across all clinical sites employing the system 10. The cloud unit 34 may include one or more servers hosted on the Internet to store, manage, and process data. The remote server 36 may be a private or public source of information maintained by an organization, such as for example, a research institute, a company, a university and/or a hospital.

Referring to FIG. 1, the controller C may be configured to receive and transmit data through a mobile application 40, which may be installed on a smartphone, laptop, tablet, desktop or other electronic device and may include a touch screen interface or I/O device such as a keyboard or mouse. The circuitry and components of a mobile application (“apps”) available to those skilled in the art may be employed.

Referring now to FIG. 3, a flow chart of method 100 executable by the controller C of FIG. 1 is shown. Method 100 need not be applied in the specific order recited herein and some blocks may be omitted. The memory M can store controller-executable instruction sets, and the processor P can execute the controller-executable instruction sets stored in the memory M.

Referring to FIG. 3, the method 100 includes a first phase 110 for gathering training data. The first phase 110 includes blocks 102, 104, 106 and 108. Per block 102, OCT historical data from various subjects is collected.

Proceeding to block 104, predefined features are extracted from the OCT historical data. Image processing techniques may be used to measure visible features in the OCT historical data. For example, the lens anterior and posterior (red curve) radius may be obtained as R in the following equation z(r)=r2/[R(1+sqrt(1−(+K)(r2/R2))]. Alternatively, the OCT historical data may be fed into an artificial intelligence algorithm, e.g., an autoencoder, to automate image feature extraction. Any number of features can be taken at this stage. If the feature is predictive of the missing biometry, the learning module 20 is adapted to assign it a relatively large weight; otherwise, the learning module 20 will ignore it.

Proceeding to block 104, predefined features are extracted from the OCT historical data and forwarded to the second phase 120 where the machine learning module 20 is trained. Per block 106, historical data from an imaging device that can capture the subject's full crystalline lens. For example, UBM historical data (corresponding to the OCT historical data) is forwarded to the second phase 120. In the UBM historical data, the full lens is visible, and features of interest may be identified using image processing.

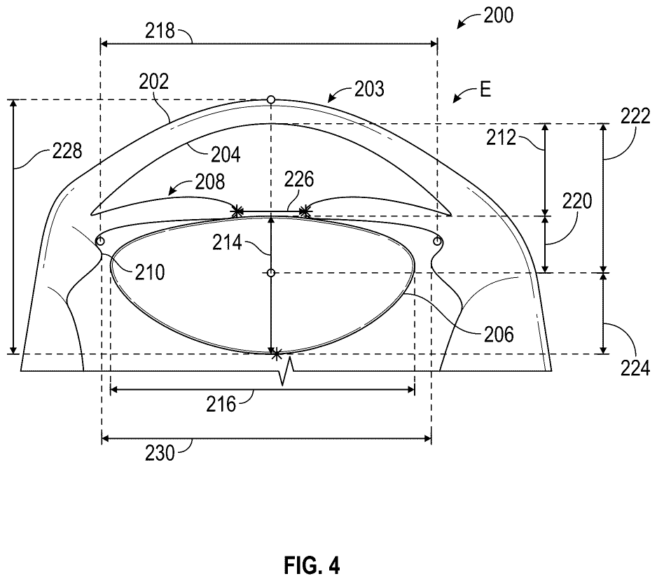

FIG. 4 shows an example pre-operative image 200 of an eye E obtained via an ultrasound bio-microscopy technique. The ultrasound bio-microscopy technique may employ a relatively high frequency transducer of between about 35 MHz and 100 MHz, with a depth of tissue penetration between about 4 mm and 5 mm. FIG. 4 illustrates an upper surface 202 of the cornea 203, a lower surface 204 of the cornea 203, the pre-operative lens 206, iris 208 and ciliary muscle 210. It is understood that the FIGS. shown herein are not drawn to scale. Referring to FIG. 4, the extracted features may include a first equatorial plane position 220 (measured from an anterior phakic pole), a second equatorial plane position 222 (measured relative to the anterior chamber depth 212) and a third equatorial plane position 224 (measured relative to a posterior phakic pole).

Per block 108, the method 100 includes collecting other patient biometry (e.g., corneal keratometry, axial length, anterior chamber depth) from an alternate instrument. In the embodiment shown, biometric historical data corresponding to the OCT historical data is forwarded to the second phase 120. The historical biometric data may include pre-operative dimensions of the eye E, such as an anterior chamber depth 212, a lens thickness 214, a lens diameter 216, and a sulcus-to-sulcus diameter 218, shown in FIG. 4. The historical biometric data may include an iris diameter 226, an axial length 228 from the cornea 203 to a posterior surface of the pre-operative lens 206 and a ciliary process diameter 230.

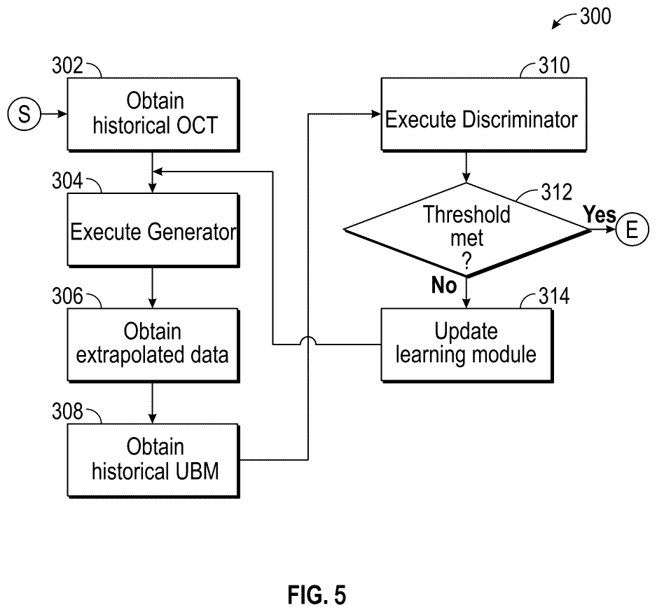

In the second phase 120 of FIG. 3, the method 100 includes training the learning modules with the training dataset from the first phase 110. In the second phase 120, the learning module 20 is trained using the features identified in blocks 104 and 106 as inputs and the features identified in block 108 as the output. An example training method 300 is shown in FIG. 5. It is understood that other training methods may be employed. Per block 302 of FIG. 5, a training OCT image is obtained. In this embodiment, the training dataset includes paired sets of data, with paired OCT and ultrasound bio-microscopy images, taken of the same patient. Per block 304 of FIG. 5, the training method 300 includes executing the generator 26. Per block 306 of FIG. 5, the generator 26 generates quantified image features based in part on the respective training OCT images, extrapolating the data obtained in block 302. The training ultrasound bio-microscopy image that pairs with the training OCT image (obtained in block 302) is retrieved in block 308.

Per block 310 of FIG. 5, the training method 300 includes executing the discriminator 28. The discriminator 28 is used to “judge” the output of the generator 26 and determine whether the output (the synthesized quantified image features of block 306) is close enough to the quantified image features obtained from the “real” training data (training ultrasound bio-microscopy image of block 308).

The training method 300 then proceeds to block 312 to determine if a predefined threshold is met. In one example, the predefined threshold is met when the difference in quantified image features between the two images is within a predefined value, such as for example, 2%. If the predefined threshold is met, the training method 300 is ended. If not, the training method 300 proceeds to block 314, where the learning module 20 is updated and the training method 300 loops back to block 304. The training process occurs in a closed loop or iterative fashion, with the learning modules 20 being trained until certain criteria are met. In other words, the training process continues until the discrepancy between the network outcome and ground truth reaches a point below a certain threshold. As the loss function related to the training dataset is minimized, the learning module 20 reaches convergence. The convergence signals the completion of the training.

Referring to FIG. 3, the method 100 includes a third phase 130 for the execution phase. The third phase 130 includes blocks 132, 134, 136, 138 and 140. Per block 132 of FIG. 3, the controller C is configured to receive patient data, including OCT data and biometric data for a test patient. Per block 134, features are extracted from the original OCT image(s) of the test patient. Referring to FIG. 2, the extracted features include the anterior lens surface curvature 52, lens thickness T, and posterior lens surface curvature 54. The extracted OCT image features and additional biometry measurements are transmitted to the trained learning module 20.

Proceeding to block 136 of FIG. 3, the trained model is executed to predict the missing lens features without having to collect UBM data for the specific patient. Per block 138 of FIG. 3, the controller C is configured to generate or predict quantified features for the specific patient as an output of the machine learning model 20. i.e., the lens features not visible in the original OCT image. Per block 140 of FIG. 4, the quantified image features may be outputted to a lens selection module 42 (see FIG. 1) for assistance selecting an intraocular lens 44 for implantation into the eye E. This information is particularly useful for intraocular lenses that are accommodative in nature, as their functional performance has been observed to be correlated to the lens diameter.

Referring now to FIG. 6, a boosted neural network 400 employable in the system 10 is shown. Boosting involves the building of a large additive neural network model through fitting a sequence of smaller models. Each of the smaller models is subsequently fit on the scaled residuals of the previous model. The boosted neural network 400 has a plurality of neural networks (“NN”), such as first NN 402 and second NN 404, that are combined to form a larger final model.

Referring to FIG. 6, the first NN 402 is a feedforward artificial neural network having at least three layers, including an input layer 410, a hidden layer 420 and an output layer 430. The number of nodes and layers in each of the plurality of neural networks may be varied based on the application at hand. Each layer is composed of respective nodes N configured to perform an affine transformation of a linear sum of inputs. The respective nodes N are characterized by a respective bias and respective weighted links. The parameters of each respective node N may be independent of others, i.e., characterized by a unique set of weights. The respective nodes N in the input layer 410 receive the input, normalize them and forward them to respective nodes N in the hidden layer 420.

Similarly, the second NN 404 has an input layer 440, at least one hidden layer 450 and an output layer 460. Each respective node N in a subsequent layer computes a linear combination of the outputs of the previous layer. A network with three layers would form an activation function ƒ(x)=ƒ(3)(ƒ(2)(ƒ(1)(x))). The activation function ƒ may be linear for the respective nodes N in the output layer 460. The activation function ƒ may be a sigmoid for the hidden layers. A linear combination of sigmoids may be used to approximate a continuous function characterizing the output vector y. The patterns recognized by each neural network may be translated or converted into numerical form and embedded in vectors or matrices.

The process of boosting may use validation to assess how many component neural networks fit, not exceeding the specified number of neural networks. By way of example of boosting, assuming a first (base) neural network having one layer and two nodes, and a total of six neural networks or models. The first step is to fit a one-layer, two-node neural network. The predicted values from that neural network are scaled by the learning rate, then subtracted from the actual values to form a scaled residual. The next step is to fit a different one-layer, two-node neural network, where the response values are the scaled residuals of the previous model. This process continues until each neural network has been fitted, or until the addition of a new neural network fails to improve the validation numbers. The plurality of neural networks is combined to form the final, large model.

The system 10 may be configured to be “adaptive” and updated periodically after the collection of additional training data. It is to be understood that the system 10 is not limited to a specific neural network methodology and other methodologies available to those skilled in the art may be employed.

In summary, the system 10 uses learning modules 20 to make the prediction after it has been trained on lens features measured using alternative imaging instruments, such as ultrasound bio-microscopy (UBM). The inputs to the learning modules 20 include, but are not limited to, visible features in the OCT image and biometry measurements collected from alternative instruments. The system 10 allows patients to be fitted for intraocular lens without requiring time-consuming UBM videos to be collected. The system 10 enables improvements in the surgical planning process for cataract surgery, including OCT-based cataract grading and planning.

The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file storage system, an application database in a proprietary format, a relational database energy management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowchart shown in the FIGS. illustrates an architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of orders (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such orders. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for assessing an eye using an optical coherence tomography (“OCT”) device, the system comprising:
a controller having at least one processor and at least one non-transitory, tangible memory on which instructions are recorded, the controller being adapted to receive an original OCT image of the eye captured via an OCT device;
at least one learning module selectively executable by the controller, the at least one learning module being trained by a training network with a dataset having respective historical ultrasound bio-microscopy images and respective historical OCT images;
wherein the controller is adapted to receive input data, including the original OCT image and biometric parameters of the eye; and
wherein the controller is adapted to execute the at least one learning module to generate one or more quantified image features of the eye based on the input data, the one or more quantified image features including a lens thickness and a lens diameter.

2. The system of claim 1, wherein the input data from the original OCT image includes an anterior lens surface curvature, a posterior lens surface and a thickness of a lens.

3. The system of claim 1, wherein the biometric parameters include an axial length, corneal keratometry, and an anterior chamber depth.

4. The system of claim 1, wherein the one or more quantified image features include a cataract grading score.

5. The system of claim 1, wherein the one or more quantified image features includes an equatorial plane position of a lens in the eye, the equatorial plane position being measured from at least one of an anterior phakic pole of the eye, an anterior chamber depth of the eye, and a posterior phakic pole of the eye.

6. The system of claim 1, wherein the at least one learning module incorporates a boosted neural network having a plurality of neural networks fitted together.

7. The system of claim 1, wherein the training network is a generative adversarial network having a generator adapted to generate respective synthesized quantified image features based in part on the respective historical OCT images and respective historical biometric parameters.

8. The system of claim 7, wherein the training network includes a discriminator adapted to compare the respective synthesized quantified image features output by the generator and respective quantified image features obtained from the respective historical ultrasound bio-microscopy images.

9. The system of claim 8, wherein training of the at least one learning module is completed when a difference between the respective synthesized quantified image features output by the generator and the respective quantified image features obtained from the respective historical ultrasound bio-microscopy images is above a predefined threshold.

10. A method for assessing an eye using an optical coherence tomography (“OCT”) device, with a system having a controller with at least one processor and at least one non-transitory, tangible memory, the method comprising:
adapting the controller to selectively execute at least one learning module;
training the at least one learning module, via a training network with a dataset having respective historical ultrasound bio-microscopy images and respective historical OCT images;
receiving input data of the eye, via the controller, including biometric parameters of the eye an original OCT image of the eye captured via an OCT device; and
executing the at least one learning module to generate one or more quantified image features based on the input data, the one or more quantified image features including a lens thickness and a lens diameter of the eye.

11. The method of claim 10, further comprising:
incorporating an anterior lens surface curvature, a posterior lens surface, and a thickness of a lens in the input data from the original OCT image.

12. The method of claim 10, further comprising:
incorporating an axial length, corneal keratometry, and an anterior chamber depth in the biometric parameters.

13. The method of claim 10, further comprising:
incorporating a cataract grading score in the one or more quantified image features.

14. The method of claim 10, further comprising:
incorporating an equatorial plane position of a lens in the eye in the one or more quantified image features, the equatorial plane position being measured from at least one of an anterior phakic pole of the eye, an anterior chamber depth of the eye, and a posterior phakic pole of the eye.

15. The method of claim 10, further comprising:
incorporating a boosted neural network in the at least one learning module, the boosted neural network having a plurality of neural networks fitted together.

16. The method of claim 10, further comprising:
incorporating a generator in the training network; and
generating respective synthesized quantified image features based in part on the respective historical OCT images and respective historical biometric parameters, via the generator.

17. The method of claim 16, further comprising:
incorporating a discriminator in the training network; and
comparing the respective synthesized quantified image features and respective quantified image features obtained from the respective historical ultrasound bio-microscopy images, via the discriminator.

18. The method of claim 17, further comprising:
training the at least one learning module until a difference between the respective synthesized quantified image features output by the generator and the respective quantified image features obtained from the respective historical ultrasound bio-microscopy images is above a predefined threshold.

19. A system for assessing an eye using an optical coherence tomography (“OCT”) device, the system comprising:
a controller having at least one processor and at least one non-transitory, tangible memory on which instructions are recorded, the controller being adapted to receive an original OCT image of the eye captured via an OCT device;
at least one learning module selectively executable by the controller, the at least one learning module being trained by a training network with a dataset having respective historical ultrasound bio-microscopy images and respective historical OCT images;
wherein the controller is adapted to receive input data, including the original OCT image and biometric parameters of the eye;
wherein the input data from the original OCT image includes an anterior lens surface curvature, a posterior lens surface and a thickness of a lens;
wherein the biometric parameters include an axial length, corneal keratometry, and an anterior chamber depth; and
wherein the controller is adapted to execute the at least one learning module to generate one or more quantified image features of the eye based on the input data, the one or more quantified image features including a lens thickness, a lens diameter, and an equatorial plane position of a lens in the eye.
